(19) United States
(12) Patent Application Publication
(10) Pub. No.: US 2014/0173970 A1
(43) Pub. Date: Jun. 26, 2014

(54) Pest Extermination Blanket

(71) Applicant: Herbert Martin, Paducah, KY (US)

(72) Inventor: Herbert Martin, Paducah, KY (US)

(21) Appl. No.: 13/722,195

(22) Filed: Dec. 20, 2012

(51) Int. Cl. A01M 13/00

(52) U.S. Cl. CPC A01M 13/003
USPC 43/124

(57) ABSTRACT

A pest extermination apparatus including a blanket and a cooling agent, such as solid state carbon dioxide positioned within the blanket. The pest extermination apparatus may also include top surface is made of insulated material, such as foam or plastic and a reflective cover positioned on the top surface. The pest extermination apparatus may further include a bottom surface having at least one channel wherein the cooling agent is positioned within the at least one channel. The at least one channel has a plurality of holes on a bottom portion thereof for allowing the cooling agent to pass through the bottom portion.

### TECHNICAL FIELD

The present disclosure relates to pest control, and more particularly to an extermination blanket containing a cooling agent such as solid state carbon dioxide for eliminating vermin and pests in human habitable areas through the use of extreme cold and the removal of available oxygen.

### BACKGROUND

An increasing problem throughout the world is the growing infestation of bed bugs and other pests and vermin in hotels, motels, college dormitories, hospitals and homes. Generally, the terms “pest” and “vermin” refer to any unwanted creature such as insects, reptiles, or rodents which have taken up habitation within a space normally occupied by humans. One of the primary reasons for this problem is due to increased mobility in travel and the rapid expansion and economy of airline flights. The pests are transported by unsuspecting travelers in their luggage and clothing and then they occupy and share the sleeping places of humans and feast upon them while they sleep. These pests can inhabit the spaces within the mattresses, deep within the coil springs, during the daytime while waiting to attack human occupants in the middle of the night and because they burrow so deeply into the mattresses and springs, they are extremely difficult to exterminate by conventional chemical means.

A common method of treating bed bugs and other vermin is spraying pesticides on the exterior of mattresses. However, this treatment method does not always reach or affect bed bugs, as they simply wait in the springs until the harmful effects have dissipated. Furthermore, spraying a mattress may be more harmful to the human sleeping on it than it is to the bed bug hidden inside of it. Indeed, often spiders, especially the dangerous brown recluse spider, will hide under the bed or lay in wait beneath the covers to strike.

Another problem associated with this extermination technique is it is not safe for humans to occupy the space during fumigation or to enter or inhabit soon after the completion of the process. Specifically, most insecticides are applied wet as a spray and leave a powdery residue after they have dried. This residue then continues to maintain the potential for harm to humans through its transference to the foods consumed or the particles that are breathed. As a result, the treated room or house cannot be occupied by persons for a lengthy period of time, i.e., typically at least twenty-four (24) hours.

Other methods for exterminating pests have been employed, many of which utilize the introduction of toxic chemicals or lethal gases, including permethrin, d-trans allethrin, methyl bromide, tetramethrin, phosphine, or the like into the extermination environment. However, this method of employing toxic chemicals poses numerous risks. Specifically, these toxic chemicals pose risks to the health of humans and damage to the ecosystem and environment as well.

As discussed above, most extermination systems known in prior art utilize spraying of harmful chemicals into the environment or the luring into entrapment of pests, such as confinement structures with sticky surfaces, and these rely on a hit-or-miss method of disposing of vermin. For example, U.S. Pat. No. 6,199,770 to King et al. provides constructing a piping system for spraying pesticides. Furthermore, U.S. Pat. No. 6,141,901 to Johnson et al. provides a method for introducing hot air into a facility and causing it to reach temperatures well above 200° F. (degrees Fahrenheit). Again, not only are these prior art methods not particularly effective at killing the pests, but they also pose serious hazards to the environment and structures upon which they are applied.

Accordingly, a need is identified for a system of treating and exterminating pests that is more efficient at terminating the pests. Specifically, the system should be effective at killing substantially all of the pests in the applied treatment area. Furthermore, a need is identified for a more environmentally friendly system of treating and exterminating pests. Specifically, the system should utilize non-toxic treatment such that the surrounding treatment area is not exposed to harmful chemicals, which allows the treated area to be occupied by humans shortly after the treatment.

### SUMMARY

One aspect of the disclosure is an apparatus for use in pest extermination. The pest extermination apparatus includes a blanket and a cooling agent positioned within the blanket. In one embodiment, the cooling agent is solid state carbon dioxide, which may be in pellet form. The apparatus may also include top surface is made of insulated material, such as foam or plastic and a reflective cover positioned on the top surface. The apparatus may further include a bottom surface having at least one channel wherein the cooling agent is positioned within the at least one channel.

In another embodiment, the at least one channel of the apparatus includes an opening in a front portion for receiving the cooling agent and a flap connected to the opening for sealing the cooling agent within the channel. Furthermore, the at least one channel has a plurality of holes on a bottom portion thereof for allowing the cooling agent to pass through the bottom portion. An adhesive material may be used along at least a portion of the perimeter of the blanket.

In another aspect of this disclosure, an extermination blanket for treating pests is disclosed. The blanket includes a top surface, a bottom surface including a plurality of pockets and a cooling agent positioned within the plurality of pockets. In one embodiment, the top and bottom surface are made from a flexible material and hingedly connected to one another. In another embodiment, the plurality of pockets are separated equidistantly from one another and aligned in rows having an equal number of pockets. In yet another embodiment, each of the plurality of pockets has a bottom portion made of a semi-permeable material, such as mesh or woven fabric to allow the cooling agent to pass through said bottom surface.

In a related aspect of this disclosure, a method for exterminating pests in a treatment area is disclosed. The method includes providing a blanket containing a cooling agent over the treatment area. The method further includes allowing the cooling agent to sublimate through the bottom of the blanket into the treatment area.

### BRIEF DESCRIPTION OF THE DRAWINGS

FIG. 1 is a perspective top view of a pest extermination blanket forming one aspect of this disclosure;

FIG. 2 is a perspective view of a bottom surface of the pest extermination blanket forming one aspect of this disclosure;

FIG. 3 is another perspective view of the bottom surface of the pest extermination blanket forming one aspect of this disclosure;

FIG. 4 is a perspective view of a top surface of the pest extermination blanket forming one aspect of this disclosure;

FIG. 5 is a perspective view of the pest extermination blanket with a cover forming one aspect of this disclosure;

FIG. 6 is a top view of the pest extermination blanket with a cooling agent positioned outside of the blanket forming one aspect of this disclosure;

FIG. 7 is a top view of the pest extermination blanket forming one aspect of this disclosure;

FIG. 8 is a bottom view of the pest extermination blanket forming one aspect of this disclosure;

FIG. 9 is a front view of the pest extermination blanket forming one aspect of this disclosure;

FIG. 10 is an expanded perspective view of the pest extermination blanket forming one aspect of this disclosure;

FIG. 11 is a side view of the pest extermination blanket in use forming one aspect of this disclosure;

FIG. 12 is a top perspective view of the bottom surface of the pest extermination blanket forming one aspect of this disclosure;

FIG. 13 is a bottom perspective view of the bottom surface of the pest extermination blanket forming one aspect of this disclosure;

FIG. 14 is a top view of the bottom surface of the pest extermination blanket forming one aspect of this disclosure;

FIG. 15 is a bottom perspective view of the top surface of the pest extermination blanket forming one aspect of this disclosure;

FIG. 16 is a side perspective view of the top and bottom surfaces of the pest extermination blanket forming one aspect of this disclosure; and

FIG. 17 is a rear perspective view of the top and bottom surfaces of the pest extermination blanket forming one aspect of this disclosure.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, a pest extermination blanket and related method of using the pest extermination blanket is hereinafter described.

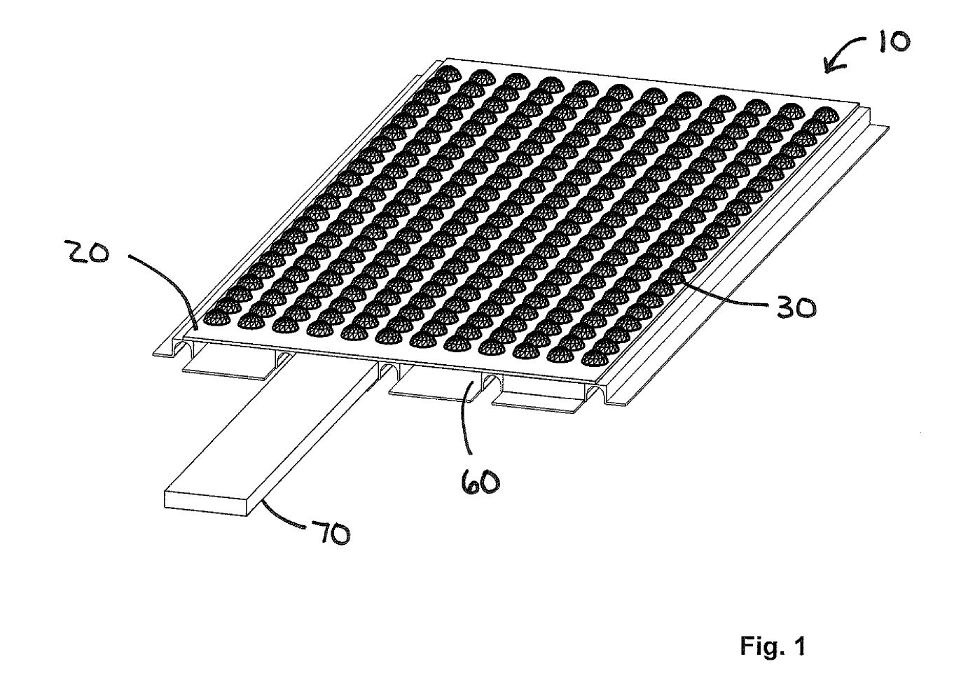

As shown in FIG. 1, the pest extermination blanket 10 is an environmentally friendly apparatus for pest extermination and control. It is designed to eliminate household pests, such as bed bugs, carpet fleas, roaches, spiders and mice by enclosing and cryogenically treating the pest-occupying zones within structures housing human occupation. Specifically, the affected areas are covered with the pest extermination blanket 10 for a certain amount of time to achieve extermination of the pests by utilizing the dual techniques of freezing and suffocating. Advantageously, the pest extermination blanket 10 is adaptable to a wide variety of structures and enclosures. Furthermore, it is easily transported into the facility, requires no permanent installation and preparatory work and cleanup are minimal. Depending on the extensiveness of the infestation of pests and vermin, more than one pest extermination blanket may be required.

In more detail, the apparatus and related method involves a technique for targeting and treating specific zones and areas in a non-toxic manner with extreme cold through a non-toxic cooling agent, which effectively poses minimal danger to the ambient environment or surrounding atmosphere. Importantly, delays in occupying the treated area for necessary extended venting also disappear as the area is safe as soon as the room temperature or the temperature of the treated piece of furniture return to normal. For example, a bed infected with bed bugs could be covered in the morning by the pest extermination blanket and slept in the same night without ever having to remove the bedding and with no staining or discoloration to the bedding occurring.

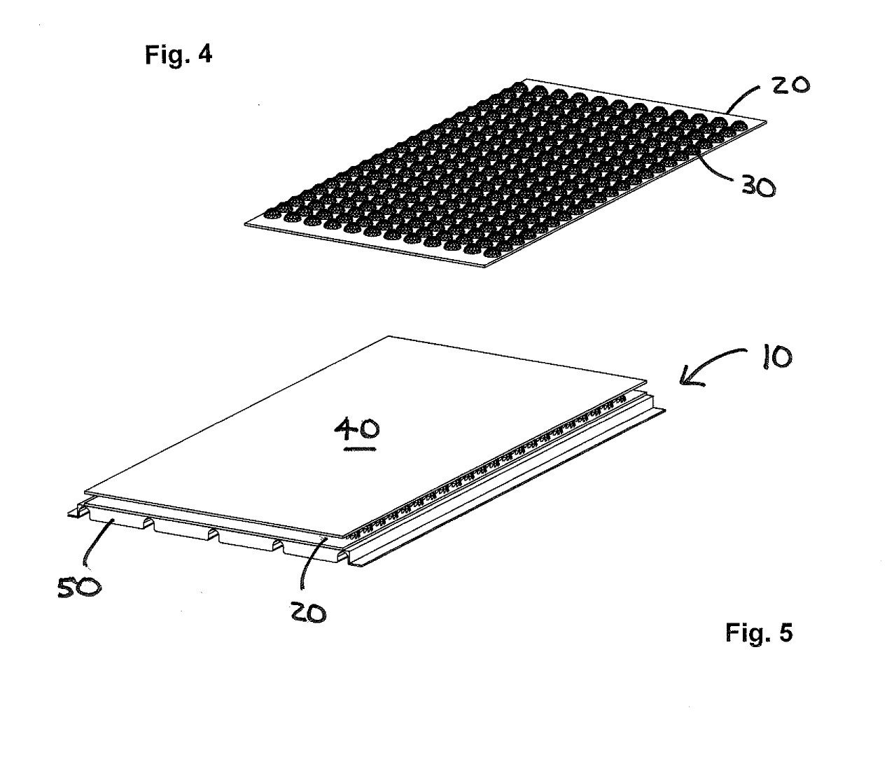

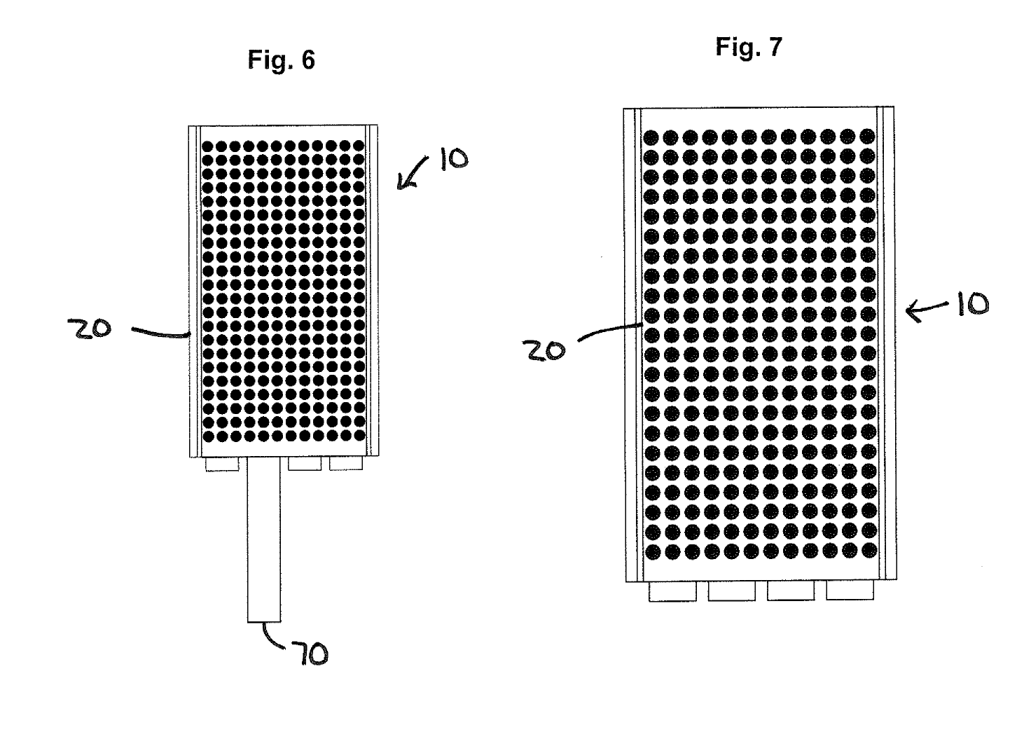

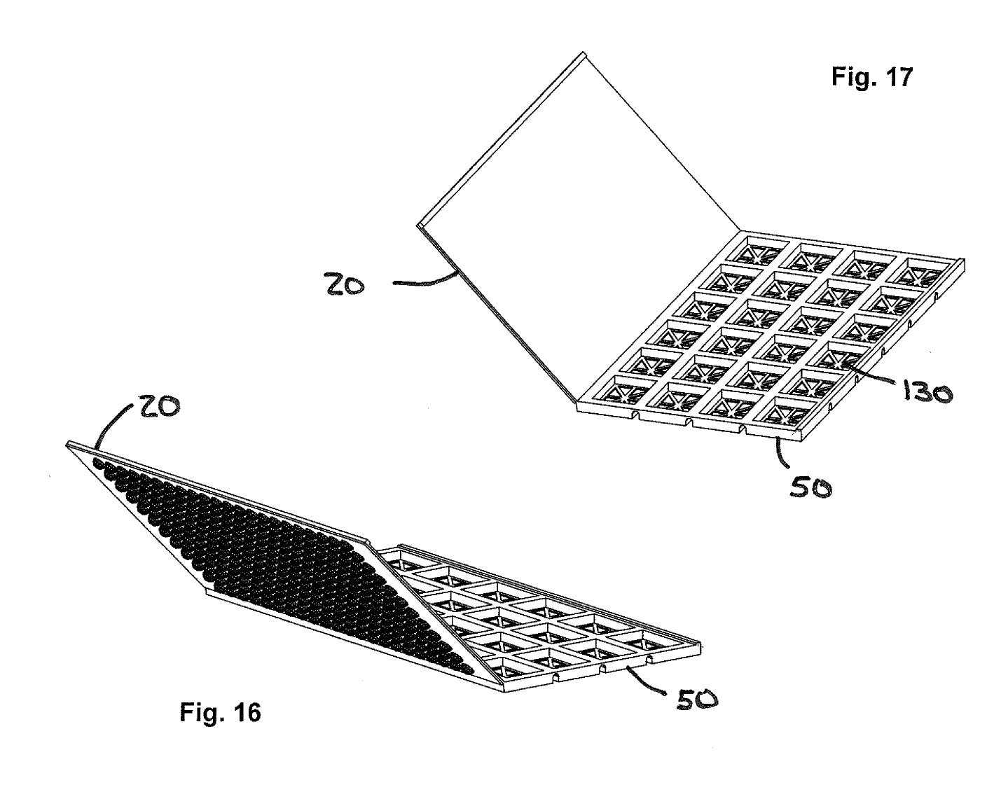

Turning to FIG. 1, the pest extermination blanket 10 may be made of plastic, cloth, paper or other suitable materials. It includes a top surface 20 made of bubble wrap, polystyrene foam, Styrofoam beads or another suitable plastic having insulative properties. As perhaps best illustrated in FIGS. 1, 4, 6 and 7, the top surface 20 has at least one side made of a bubble wrap material having multiple protruding bubbles 30 formed of air or foam, i.e., a top side of the top surface may include the bubble wrap, while the bottom side of the top surface is made of a reflective material (see FIGS. 16 and 17).

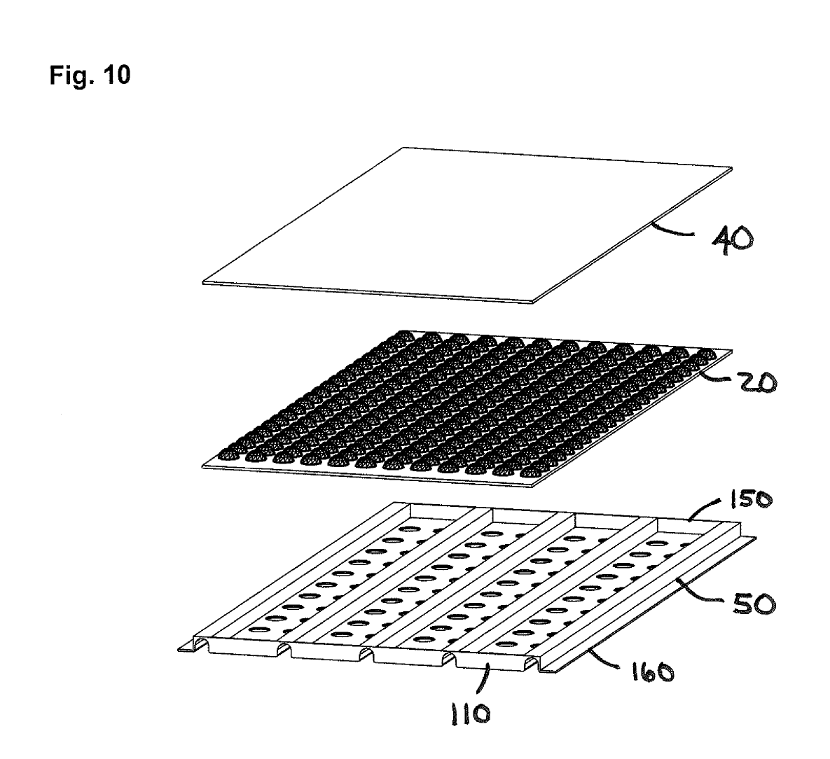

As shown in FIGS. 5 and 10, a cover 40 may be positioned on top of the top surface 20. The cover 40 may be made of flexible foam, a reflective material such as aluminum foil or a composite of both or other insulating and reflective materials. The cover 40 is used to direct the extreme coldness downward and to extend the life of the cooling agent (discussed below) so as slow the sublimation of the dry ice or other non-toxic gas and to extend the duration of the extermination treatment period to longer lengths of time thereby reaching lower temperatures within the extermination area.

As noted above, the top surface 20 may be made of at least partially of a bubble wrap or similar material, such that the trapped air in the bubble wrap provides similar insulating qualities as the insular reflective cover. Furthermore, both the top surface 20 and the cover 40 enhance the separation of the cooling agent, such as dry ice from the warmer air outside of and surrounding the pest exterminating blanket 10. Additional benefits may be attained by using the reflective cover 40 with the top surface 20 composed of the bubble wrap material simultaneously.

In one embodiment, the pest extermination blanket 10 also includes a bottom surface 50 having at least one channel or trough 60. The bottom surface 50 is positioned below the top surface 20. The top surface may be affixed to the bottom surface through a hinged connection as shown in FIG. 16. Furthermore, matching Velcro strips on the top and bottom surfaces may be used to connect the surfaces. In other embodiments, the top surface 50 may be affixed to the bottom surface by adhesives or other fastening devices. Also, the top surface 50 may be placed over the bottom surface without any connection means.

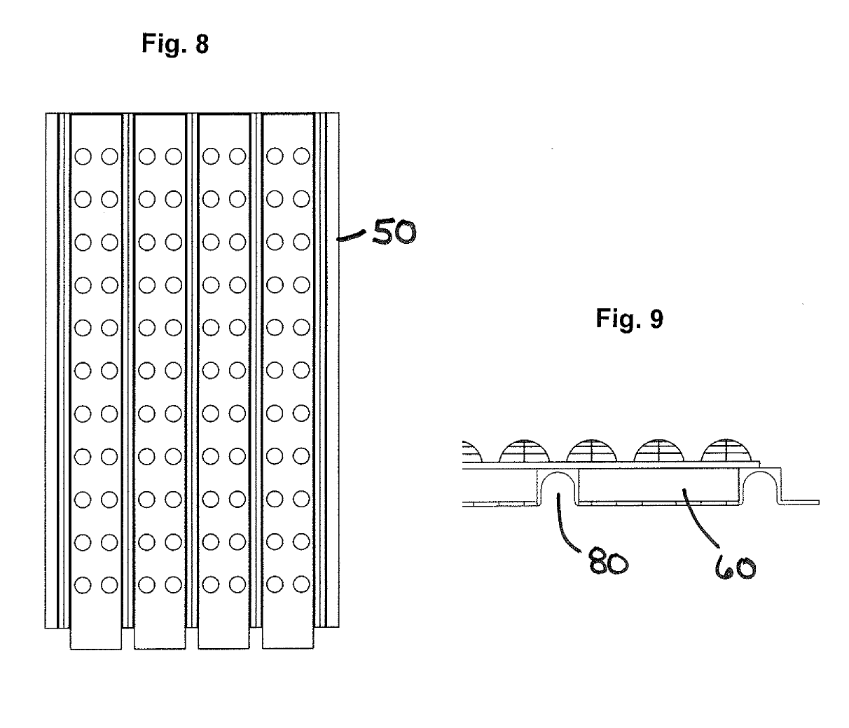

As shown in FIGS. 1-3 and 8, there are four channels 60 located under the top surface 20, but it should be appreciated that a greater or smaller number of channels may be used with the pest extermination blanket 10. The channels 60 are configured to receive a cooling agent 70, such as solid state carbon dioxide CO₂ (also known as dry ice) in pellet or bead form. However, other cooling agents may be used such as inert gases.

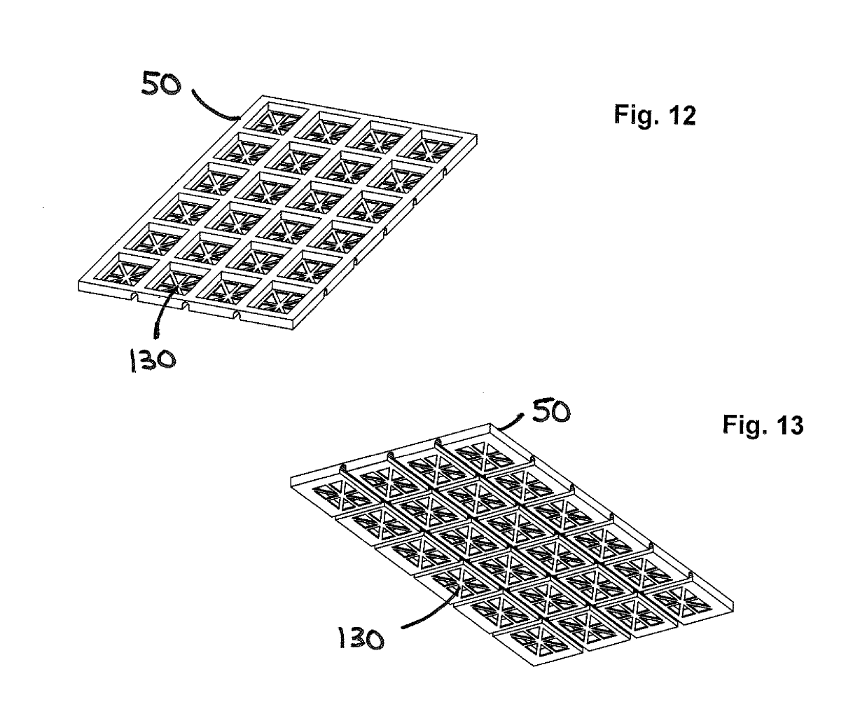

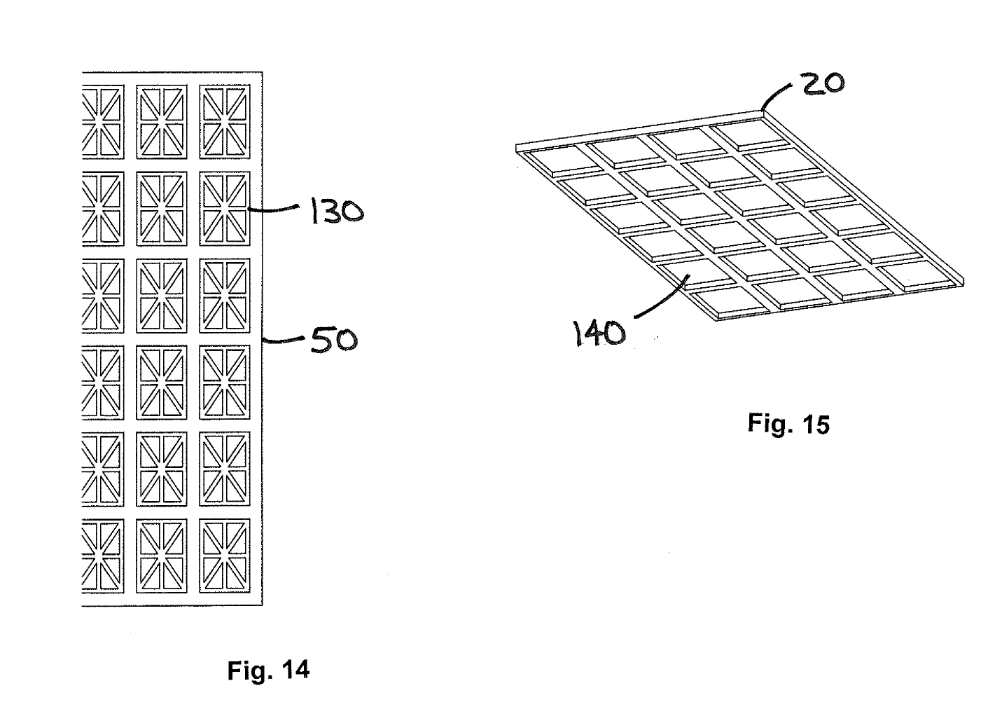

In another embodiment illustrated in FIGS. 12-14, the bottom surface 50 may incorporate a plurality of pockets 130 configured to receive a cooling agent. In this embodiment, the top surface 20 may include a plurality of corresponding pockets 140 on its underside to mate with the bottom surface 50 (see FIG. 15). The plurality of pockets 130 are typically not completely solid (i.e., has openings) or at least semi-permeable to permit the cooling agent (i.e., the sublimation of the dry ice) into the extermination area. The plurality of pockets 130 may be separated equidistant from one another and aligned in rows having an equal number of pockets. Of course, the plurality of pockets may be spaced and aligned in other arrangements.

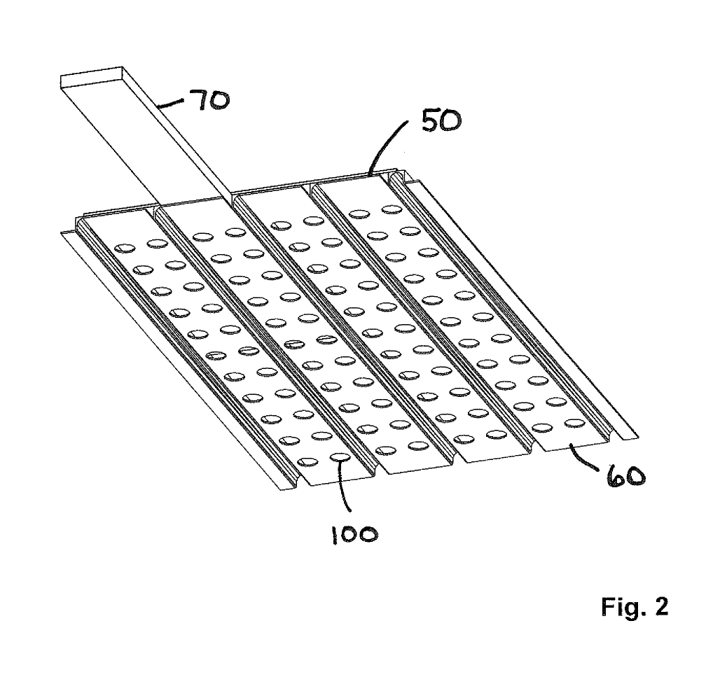

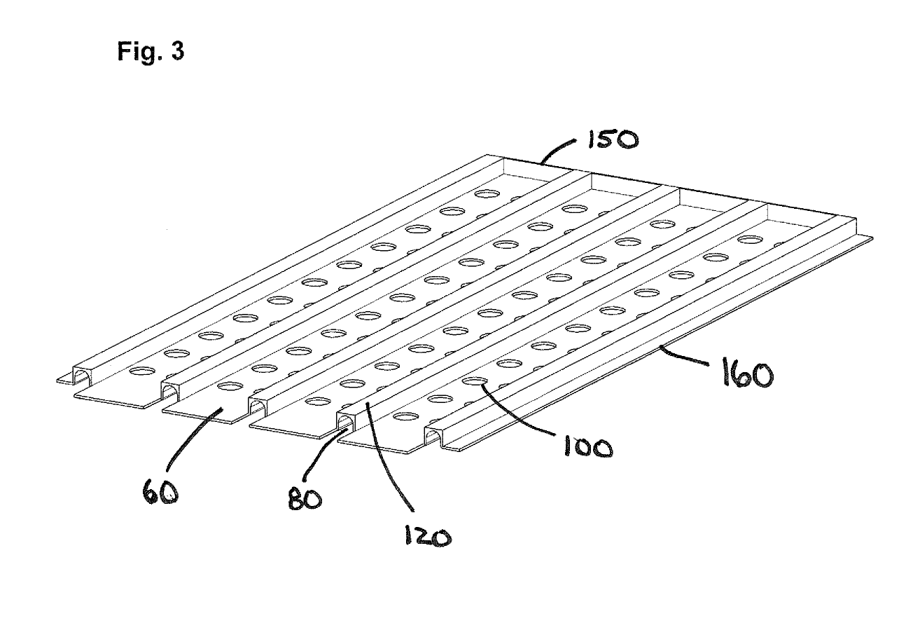

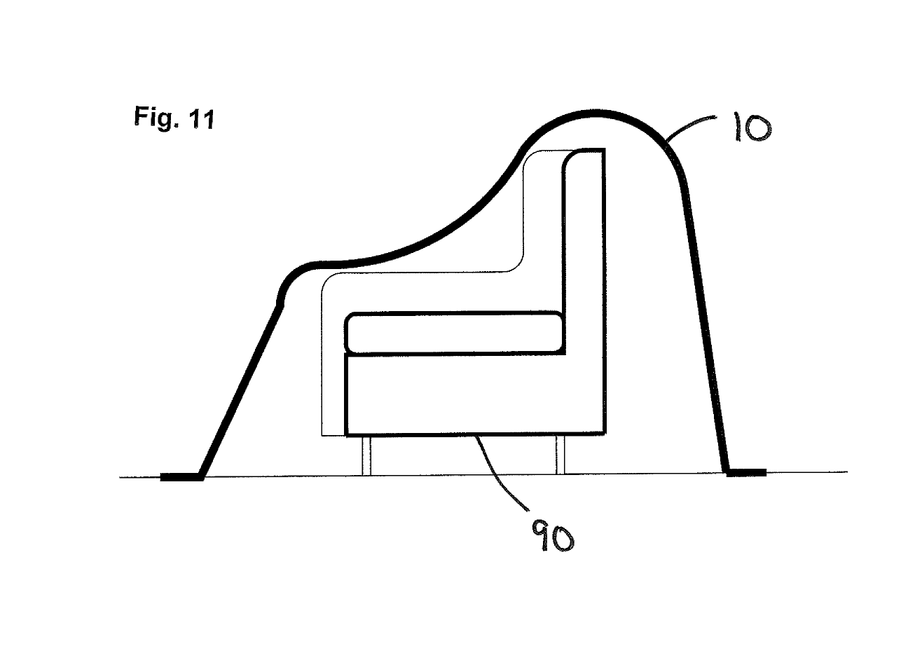

Turning to FIGS. 2 and 3, the channels 60 are parallel to one another and spaced or separated equidistant from each other. Again, it should be appreciated that other embodiments wherein the channels are not parallel to one another and/or not equidistantly spaced is contemplated. A gap or space 80 (see FIG. 9) is located between each of the channels 60, which permits the otherwise rigid pest extermination blanket 10 to be rolled into cylinders, for shipping or storage, while additionally providing sides for the channels 60. As shown in FIG. 11, the gaps 80 also allow the pest extermination blanket 10 to be draped over essentially any shape of furniture 90. Indeed, the pest extermination blanket 10 is intended to be spread completely over the object, area, or space that is contaminated with an infiltration of pests.

The bottom of each of the channels 60 has a plurality of holes 100 to permit the cooling agent (i.e., the sublimation of the dry ice) into the extermination area. As a result, the pest extermination blanket 10 may be introduced into and target specific infested areas without the dangers of humans inhaling poisons or harming the immediate surroundings, and it can then cryogenically eliminate unwanted pests through freezing or suffocation. The channels 60 are designed to receive and store the dry ice until and while sublimation occurs. The bottom of each of the channels 60 may be made of woven fabric or mesh or similar material having holes that enable the sublimated gas to pass through to the exterminating chamber or to the space directly beneath the bottom surface 50 if the said blanket is placed over a flat surface such as a mattress or a flea-infested carpet.

The cooling agent 70, such as dry ice in pellet or bead form, is typically inserted completely into the channels or pockets and sealed in by the use of flaps. Generally, the dry ice is positioned within the channels or pockets before the top surface 20 is adhered to the bottom surface 50 by the use of Velcro, adhesive or some other fastening means. The top edge of the bottom surface 50 includes back flaps 150, which are permanently sealed to prevent the dry ice from passing through as it is being inserted. After the dry ice has been inserted, and when the top surface 20 is adhered to the material 120 over the gaps 80 in the channels and along the edges and the front flaps 110 are sealed, such that the pest extermination blanket 10 is completely assembled. An adhesive such as double-sided tape may be applied around the perimeter of the pest extermination blanket along the edges to permit the blanket to be attached to another blanket or to the floor, ceiling, wall or other hard surface for greater coverage and/or improved sealing. Specifically, the edges of the blanket 10 have side flaps 160 to which the adhesive is applied for sealing purposes.

In use, the blanket is draped over the infested furniture, such as chairs, beds, carpets, and clothes, which effectively traps the unwanted creatures underneath, so that the falling cold carbon dioxide will permeate any fibers within the confines of the blanket, including the interiors of mattresses, carpets, or chairs, and cause the cessation of life. Entire rooms can be sealed off and treated in this manner as long as temperatures and CO₂ levels are allowed to become lethal to the pests. Once the blanket 10 is removed and the carbon dioxide returns to room temperature, it quickly dissipates into normal air with oxygen returning to normal levels. The additional CO₂ may also be beneficial to any plant life within the treatment areas or space.

As the dry ice, which in a solid state sublimates at a temperature of minus 109 degrees Fahrenheit, the super-cold carbon dioxide (because it is heavier than air and cold air is heavier than warm air) settles downward through the holes or woven fabric and into the space that is covered by said blanket. Specifically, the cooling agent gas sublimates into the extermination chamber under the top surface of the blanket. The continuous top surface traps the sublimed CO₂ or other cooling agent and concentrates it downward within the area that is to receive the extermination process. The plurality of holes in the bottom surface via woven fabric or mesh permits the sublimated gas to escape in solely in the downward direction as the pockets are sealed in every other direction.

As the sublimated gas surrounds, penetrates and permeates any porous materials that it settles around, this process effectively creates an extermination chamber, and any creatures that are trapped within said space are killed by means of both cryogenics and suffocation. Namely, the instant cold causes the pest's movement to be slowed, and the carbon dioxide cuts off its oxygen supply. As a result, the pests are subsequently frozen and suffocate. The amount of time and the quantities of dry ice needed for the process to occur depend upon several factors such as outside air temperature and the thickness of materials being permeated.

Normally, bed bugs are able to hide deep within the layers and coils of mattresses thereby rendering the techniques of spraying the exteriors with poisonous chemicals useful only in creating toxic and harmful effects for humans through the use of lethal gases. Subzero temperatures and carbon dioxide gas can penetrate these spaces in the coils of mattresses and the cushions of seats and find the hiding places of vermin without presenting a danger to humans or to the environment. Extended cryogenic periods in using this present invention may also be effective in the destruction of insect eggs, pupae, and larvae. The blanket may be placed over beds, chairs, clothes in closets, furniture for storing clothing, roach-infested cupboards, and flea-infested carpets.

If the cooling agent used is in pellet form in the pockets, the blanket can easily be draped to conform to the shape of the contamination space. However, if rigid slats of the cooling agent are used as in the channel version of the blanket, those slats may also be broken into chips to conform to the shape. The top reflective cover and the bottom unit with the dry ice containment pockets or channels may be manufactured independently and designed with Velcro adhesives to them to be separated and reassembled so that the pockets can be restocked with dry ice thereby making the blankets reusable. Completely sealed variations of the blanket can also be constructed of biodegradable plastic and may be easily disposed of after use.

The foregoing descriptions of various embodiments are provided for purposes of illustration and not intended to be exhaustive or limiting. Modifications or variations are also possible in light of the above teachings. The embodiments described above were chosen to provide the best application to thereby enable one of ordinary skill in the art to utilize the disclosed embodiments and with various modifications as are suited to the particular use contemplated. All such modifications and variations are within the scope of the claimed inventions.

1. A pest extermination apparatus, comprising:
a blanket; and
a cooling agent positioned within the blanket.

2. The apparatus according to claim 1, wherein the cooling agent is solid state carbon dioxide.

3. The apparatus according to claim 1, wherein the solid state carbon dioxide is in pellet form.

4. The apparatus according to claim 1, further including a top surface.

5. The apparatus according to claim 1, wherein the top surface is made of insulated material, such as foam or plastic.

6. The apparatus according to claim 4, further including a reflective cover positioned on the top surface.

7. The apparatus according to claim 1, further including a bottom surface having at least one channel.

8. The apparatus according to claim 7, wherein the cooling agent is positioned within the at least one channel.

9. The apparatus according to claim 7, wherein the at least one channel has an opening on a front portion for receiving the cooling agent.

10. The apparatus according to claim 9, wherein the at least one channel has a flap connected to the opening for sealing the cooling agent within said at least one channel.

11. The apparatus according to claim 7, wherein the at least one channel has a plurality of holes on a bottom portion thereof for allowing the cooling agent to pass through said bottom portion.

12. The apparatus according to claim 1, further including an adhesive material along at least a portion of a perimeter of the blanket.

13. An extermination blanket for treating pests, comprising:
a top surface;
a bottom surface including a plurality of pockets; and
a cooling agent positioned within the plurality of pockets.

14. The blanket according to claim 13, wherein the plurality of pockets are separated equidistant from one another.

15. The blanket according to claim 13, wherein the plurality of pockets are aligned in rows having an equal number of pockets.

16. The blanket according to claim 13, wherein the top surface is hingedly connected to the bottom surface.

17. The blanket according to claim 13, wherein the top and bottom surface are made from a flexible material.

18. The blanket according to claim 13, wherein each of the plurality of pockets has a bottom portion made of a semi-permeable material to allow the cooling agent to pass through said bottom surface.

19. The blanket according to claim 18, wherein the semi-permeable material is mesh or woven fabric.

20. A method for exterminating pests in a treatment area, comprising:
providing a blanket containing a cooling agent over the treatment area; and
allowing the cooling agent to sublimate through the bottom of the blanket into the treatment area.
